(19) United States
(12) Patent Application Publication
(10) Pub. No.: US 2014/0019223 A1
(43) Pub. Date: Jan. 16, 2014

(54) SYSTEM AND METHOD FOR USING PAYMENT CARDS

(71) Applicant: Dean Mavrikis, Oyster Bay, NY (US)

(72) Inventor: Dean Mavrikis, Oyster Bay, NY (US)

(21) Appl. No.: 13/545,613

(22) Filed: Jul. 10, 2012

(51) Int. Cl. G06Q 30/02

(52) U.S. Cl. 705/14.27; 705/14.65; 705/14.58; 705/14.35

(57) ABSTRACT

A system and method are provided for using payment cards. The method includes issuing promotion offers pertaining to the payment cards in real time. The method further includes redeeming the promotion offers in real time at a point of sale.

### TECHNICAL FIELD

The present principles relate generally to payment cards and, more particularly, to a system and method for using payment cards.

### BACKGROUND

Current payment cards and their systems and methods of use suffer from many deficiencies including, for example, a lack of speed and ease of implementation with regard to issuing, assigning, modifying, and redeeming promotion offers.

### SUMMARY

These and other drawbacks and disadvantages of the prior art are addressed by the present principles, which are directed to a system and method for using payment cards.

According to an aspect of the present principles, there is provided a processor-based method for using payment cards. The method includes issuing promotion offers pertaining to the payment cards in real time. The method further includes redeeming the promotion offers in real time at a point of sale.

According to another aspect of the present principles, there is provided a payment card system. The system includes a payment card management server for issuing promotion offers pertaining to payment cards in real time. The system further includes a point of sale redeeming server for redeeming the promotion offers in real time at a point of sale.

According to yet another aspect of the present principles, there is provided a non-transitory recording medium including a computer readable program that when executed by a computer system causes the computer system to perform the following steps. A step includes issuing promotion offers pertaining to the payment cards in real time. A step includes redeeming the promotion offers in real time at a point of sale.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram showing an exemplary processing system 100 to which the present principles may be applied, in accordance with an embodiment of the present principles;

FIG. 2 is a block diagram showing an exemplary system 200 for using payment cards, in accordance with an embodiment of the present principles;

FIG. 3 is a flow diagram showing an exemplary method 300 for using payment cards, in accordance with an embodiment of the present principles; and

FIG. 4 is a flow diagram showing another exemplary method 400 for using payment cards, in accordance with an embodiment of the present principles.

### DETAILED DESCRIPTION

The present principles are directed to a system and method for using payment cards. While the present principles are described in terms of payment cards, it is to be appreciated that as used herein the term “payment cards” is intended to cover cards and/or tokens having one or more attributes of a gift card, a loyalty card, a credit card, a debit card, a charge card, a stored-value card, and/or so forth. That is, the present principles can advantageously be implemented in a card or token having one or more attributes of one or more of the preceding types of cards as well as other types of cards. Thus, as can be readily appreciated given the teachings of the present principles provided herein, the present principles have broad applicability to many different types of payment and commerce systems. Moreover, the present principles can advantageously be used in many different types of commercial environments. For example, the present principles can, but are not limited to, use in any of the following commercial environments: foodservice; recreation; leisure; retail; and so forth. It is to be appreciated that the present principles can be directly incorporated into virtually any Point of Sale (POS) network. Such incorporation may even be facilitated remotely for ease of implementation.

In an embodiment, the present principles involve a payment card hereinafter referred to as an “iCard”. Of course, the features and benefits of the present principles are not contingent on the card name or identifier and, thus, the preceding card name is simply provided for illustrative purposes. A system and method of using the iCard as disclosed herein provides specific features and advantages not provided by any prior art payment card systems and methods. For example, new promotions applicable to the iCard can be issued in real time, existing promotion offers can be modified in real time, and all promotion offers can be redeemed instantly at a point of sale. In this way, merchants can dynamically and continuously provide promotions to entice customers, and customers can take advantage of such promotions.

As used herein, “issuing promotion offers in real-time” and variations thereof refer to the acts of registering a promotion offer with a payment card system and making the promotion offer public. The registering portion allows for a promotion offer to be recognized by the payment card system as valid for redemption during a subsequent redemption process. A promotion offer can be made public by specifying the promotion offer in one or more publically accessible places. The “publicizing” of the promotion allows for the promotion offer to be recognized by a payment card subscriber as valid for redemption during a subsequent redemption process. In the preceding context, public can refer to one or more persons. It is to be appreciated that in some embodiments, the publicizing portion is the only portion performed in real time, as a promotion offer may be pre-registered for release, but only released (made public and thus redeemable) for certain when a deliberate action for the promotion offer to be made public is undertaken, e.g., by an authorized person. In this way, the authorized person or the system can pre-register one or more promotion offers at their convenience, and subsequently put the promotion offers into place (i.e., make it redeemable) very quickly and easily. For example, in an embodiment, at the end of a register of a registration process, a simple button or the like may be actuated to simply forward the promotion offer to pre-designated locations for public viewing.

In another embodiment, the present principles relating to the iCard can be implemented together with a survey tool. The card program and survey tool work in tandem and fuel each other's growth. The card is designed to help merchants stimulate sales and loyal business through the power of customized promotional offers that can be electronically assigned and altered in real-time. The survey tool links data collected from POS terminals to an online survey featuring questions prepopulated with purchased items from a restaurant's menu. Various incentives can be offered to prompt card purchases after a survey is taken. In an embodiment, the card program and survey tool are separate POS applications. Of course, other implementations can also be realized given the teachings of the present principles provided herein.

A unique payment card platform, the iCard can be earned, redeemed and reloaded by consumers in many ways. Several exemplary ways in which to use the iCard are described herein. Of course, given the teachings of the present principles provided herein, one of ordinary skill in the art will readily recognize other ways in which to use the iCard and attendant system and method, while maintaining the spirit of the present principles.

It is to be appreciated that one or more embodiments described herein may be so described with respect to a restaurant environment. However, as noted above, the present principles are not limited solely to restaurants or foodservice in general and can be used with any other types of business as readily determined by one of ordinary skill in the art given the teachings of the present principles provided herein, while maintaining the spirit of the present principles. For example, but by no means totally inclusive, the present principles can be used in other environments besides foodservice including, but not limited to, recreation (e.g., sporting events, vacations, etc.), leisure (e.g., spas, hairdressing, etc.), and retail (e.g., clothes, cars, jewelry, etc.).

Moreover, it is to be appreciated that one or more embodiments described herein may be so described with respect to a payment card referred to herein as an iCard. However, the present principles can be implemented in any type of token including, but not limited to, a coin, a key fob, and so forth.

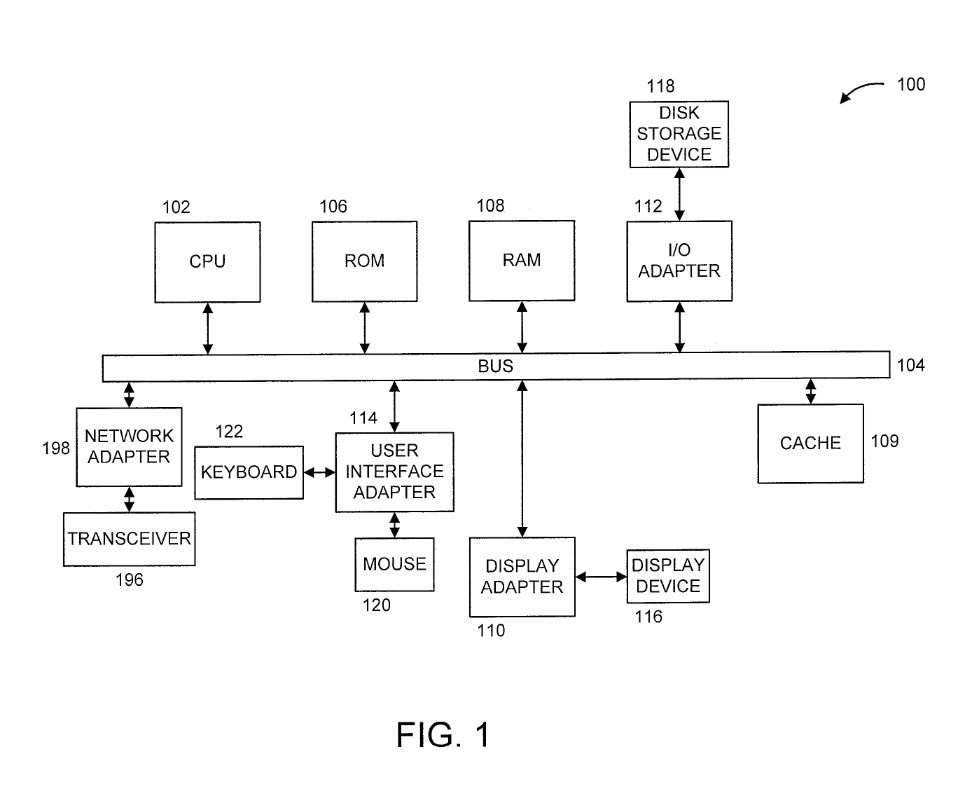

FIG. 1 shows an exemplary processing system 100 to which the present invention may be applied, in accordance with an embodiment of the present principles. The processing system 100 includes at least one processor (CPU) 102 operatively coupled to other components via a system bus 104. A read only memory (ROM) 106, a random access memory (RAM) 108, a display adapter 110, an input/output (I/O) adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A transceiver 196 is operatively coupled to system bus 104 by network adapter 198. Of course, the processing system 100 may also include other elements (not shown), as readily contemplated by one of skill in the art, as well as omit certain elements.

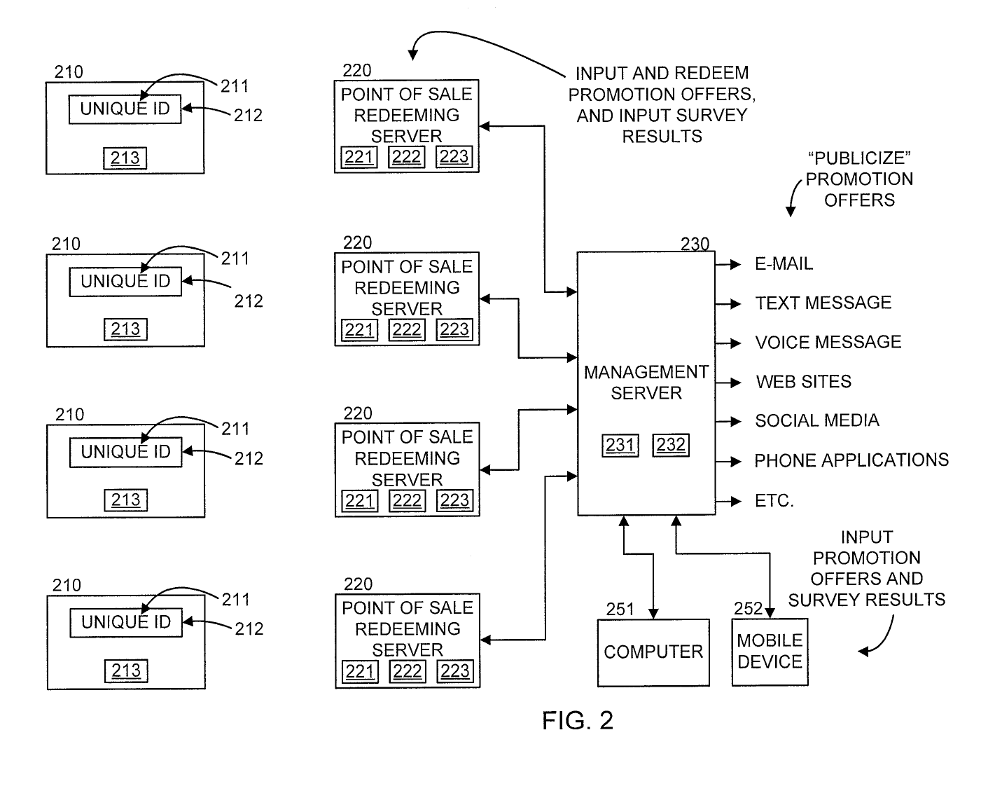

Of course, the processing system 100 may also include other elements (not shown), as readily contemplated by one of skill in the art, as well as omit certain elements. For example, system 200 described below with respect to FIG. 2 is a system for implementing a respective embodiment of the present principles. Part or all of processing system 100 may be implemented in one or more of the elements of system 200 such as, for example, the servers 220, the server 230, the computer 251, and the mobile device 252 of FIG. 2.

Additionally, elements of processing system 100 such as, for example, the keyboard 122 and mouse 120, may be omitted. In such a case, a user can interface with the processing system 100 via the transceiver 196 and/or other means. For example, a user may interface with the server 230 when inputting a promotion offer into the system 200 using a computer 251. In such a case, the user can use the keyboard and mouse of the computer 251 and, hence, not that of the server 230. Thus, depending upon the implementation of the server 230, certain elements may be omitted therefrom and/or simply not used. The same applies to the other elements shown in FIG. 1. These and other variations of processing system 100 and the elements included therein are readily contemplated by one of ordinary skill in the art, while maintaining the spirit of the present principles.

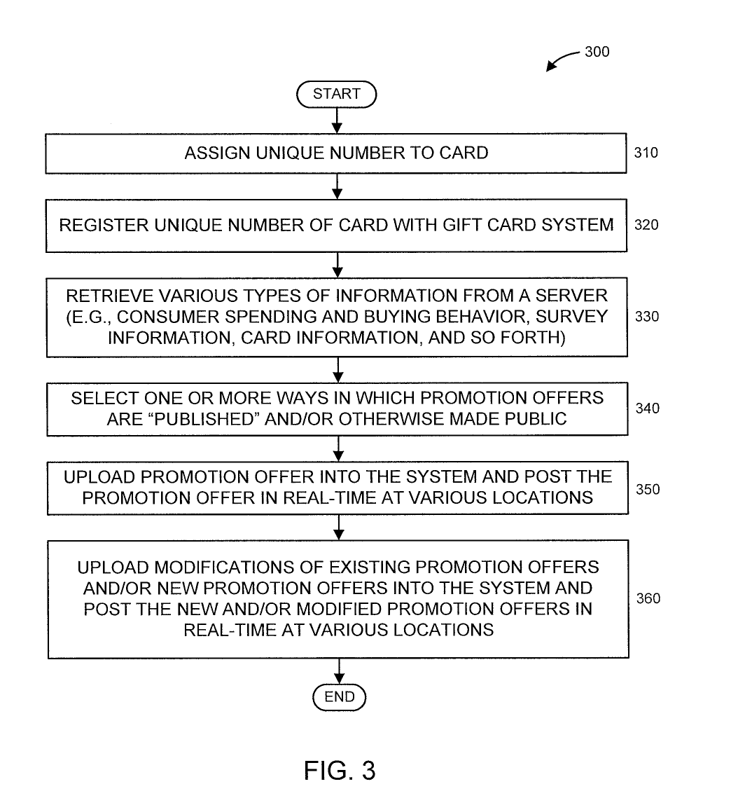

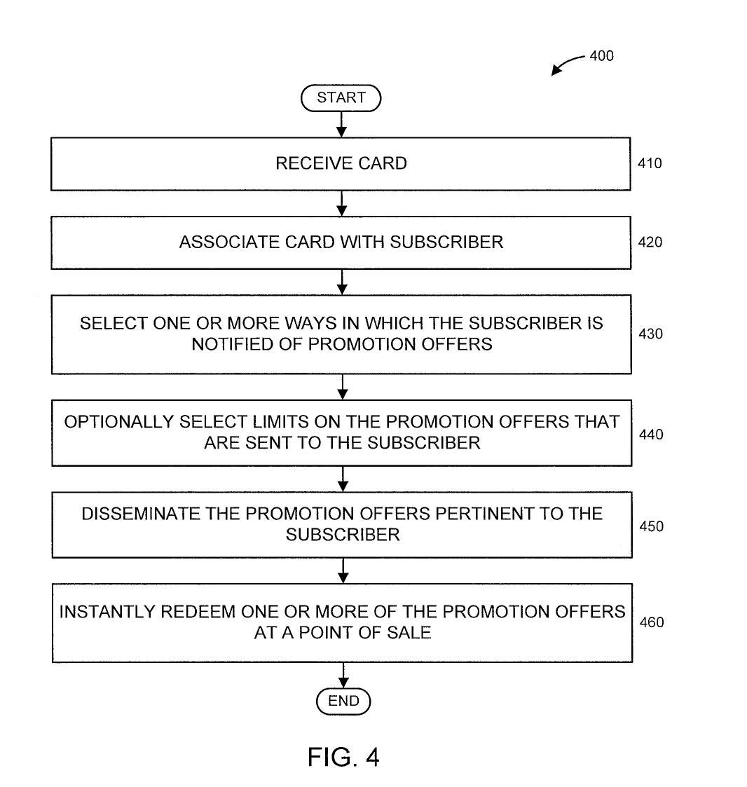

Moreover, it is to be appreciated that processing system 100 may perform at least part of the methods described herein including, for example, parts of method 300 of FIG. 3 and method 400 of FIG. 4.

FIG. 2 shows an exemplary system 200 for using payment cards (hereinafter “payment card system” or “system”), in accordance with an embodiment of the present principles. The system 200 includes a set of cards 210, a set of point of sale redeeming servers 220, and a management server 230.

Each of the cards 210 is intended to be sold or given to a consumer depending upon the particular implementation. Each of the cards includes and/or is otherwise associated with a unique identifier. In an embodiment, each of the cards includes a unique card identification number (e.g., a corresponding barcode) 211 embedded onto a magnetic strip 212 or simply printed on a voucher. In an embodiment, each of the cards 210 includes the unique card identification number 211 stored in a corresponding on-card memory 213. Of course, other ways of including and/or otherwise associating a unique identifier with each card can be used, while maintaining the spirit of the present principles.

Each of the servers 220 is located at a point of sale (e.g., within a restaurant or other type of establishment). Of course, each establishment can include more than one of the servers 220. In an embodiment, the servers 220 can be readily integrated into an establishment's existing point of sale equipment. In an alternate embodiment, the establishment's existing point of sale equipment can be modified to include the functionality of servers 220.

The balance of the cards may be determined and/or the redeemed at the servers 220. A server 220 interfaces with a card 210 by either a user swiping the card in a card reader 221 or manually entering a card identification number 211 using a user interface (e.g., a mouse, keyboard, and/or microphone) 222 on the server 220 or by scanning a card identification number 211 (e.g., a barcode) using a scanner (e.g., a barcode scanner) 223. We note that many existing point of sale systems currently have a scanner already built in for the purpose of scanning guest checks. Of course, other ways of retrieving information from the card can also be used, while maintaining the spirit of the present principles.

The servers 220 can also provide different types of information related to the cards and their use. Such information may be restricted such that it is capable of being viewed by only authorized personnel. For example, consumer spending and buying behavior may be provided to an establishment proprietor. Such behavior may be determined from the use of one or more cards associated with a given subscriber. Moreover, survey results from a given subscriber (establishment patron) can be input into the server 220, for example, as part of a promotion offer redemption process or even when a promotion offer is not redeemed but a purchase is nonetheless made or simply based on the subscriber's experience in an establishment when no sale is made. Some or all of such information may be used to generate a new promotion offer to be assigned and/or otherwise made available to card subscribers. Moreover, such information can be retrieved for review using any computer and/or mobile device, for example, after completing a secure log-in process. In this way, a person formulating a promotion offer can consider all of the preceding relevant information in order to specifically tailor the promotion to obtain a desired effect.

The servers 220 can also be used to input promotion offers into the system 200. For example, the action of inputting a promotion offer into the system 200 may register that promotion offer with the system to enable (allow) subsequent redemption of that promotion offer while also concurrently posting (publicizing) the promotion offer in one or more pre-designated and/or dynamically designated locations. Such locations can include and/or otherwise involve, but are not limited to, an e-mail address, a text message address, a voice messaging system, one or more affiliated websites (e.g., establishment's website, system owner/operator's website, social media website, and so forth), a smartphone application, and so forth.

Moreover, promotion offers can be inputted to the system 200 using any web-enabled computer 251 and/or mobile device 252. Preferably, such functionality is only enabled after the computer 251 and/or mobile device 252 complete a secure log-in process with the server 230. Thus, while only one computer 251 and only mobile device 252 are shown for the sake of simplicity in illustration, any number of such devices can be used in accordance with the present principles. In this way, each establishment can readily enter promotion offers into the system 200, even while on the go using a mobile device.

The servers 220 interface with the server 230. In an embodiment, there is only one server 230, although one or more others can be added for redundancy sake or parallel processing.

In an embodiment, the server 230 can be configured to receive survey results from card subscribers. In such a case, a secure login process can be used. In an embodiment, any web-enabled computer 251 or mobile device 252 can be used to input survey results into the system 200 via the server 230.

The server 230 can be configured to store all promotion offers (e.g., both current and past), card information, card related information (the immediately preceding two hereinafter referred to as “card information” in short), survey information, and survey related information (the immediately preceding two hereinafter referred to as “survey information” in short). Thus, server 230 is a repository of information capable of being viewed by clients (e.g., establishment proprietors and employees). Such information can be used for a variety of purposes including, but not limited to, determining current menus, the worthiness of keeping any past menu items, buying trends, promotion offer trends, creating new promotion offers, evaluating past promotion offers, and so forth.

In an embodiment, the server 230 includes a payment card manager 231 and a loyalty card manager 232. The payment card manager 231 manages payment card attributes applied to the card. The loyalty card manager 232 manages loyalty card attributes applied to the card. In this way, a card in accordance with the present principles can include the benefits of both types of cards. Of course, in an alternate embodiment, the functions of the payment card manager 231 and loyalty card manager 232 can be performed by a single entity or other entities within management server 230, while maintaining the spirit of the present principles. We again note that as used herein the term “payment card” is intended to cover a card having one or more attributes of one or more of a gift card, a loyalty card, a credit card, a debit card, a charge card, a stored-value card, and/or so forth. Nonetheless, FIG. 2 shows a separate manager 232 for loyalty card attributes to particularly emphasize that in an embodiment the payment card can include loyalty card features. Of course, other embodiments can utilize a single manager to manage all of the features possessed and/or otherwise implicated by the card, while maintaining the spirit of the present principles.

FIG. 3 shows an exemplary method 300 for using payment cards, in accordance with an embodiment of the present principles. Method 300 is primarily directed to registering payment cards for use with a payment card system and for issuing promotion offers that are redeemable using the payment cards. Hence, method 300 can be performed, for example, by an establishment proprietor or employee thereof. While method 300 is described with respect to a single card for the sake of simplicity in illustration, method 300 is intended to involve as many cards as desired for immediate use by a given establishment and/or other authorized issuing entity.

In an embodiment, method 300 is performed at the location of a particular establishment that is to promulgate the offers and process the corresponding sales. However, part of all of method 300 can be performed at other locations, including while on the go. In an embodiment, method 300 is performed by an authorized entity.

At step 310, a unique number is assigned to a particular card. Step 310 may include generating the unique number.

At step 320, the unique number of the particular card is registered with a payment card system (hereinafter the “system”). Such a system may be system 200 of FIG. 2. This registration process readies the particular card for use. That is, the card is ready for distribution to a subscriber. Once the subscriber is associated with a particular card (see, e.g., FIG. 4), then the card is actually ready for use by that subscriber as then both the card and the associated user will be registered with the system and with respect to each other.

At step 330, various types of information are retrieved from a server 230. Such information can include consumer spending and buying behavior, survey information, card information, and so forth. We note that “consumer spending and buying behavior” is an item that is automatically tracked for a consumer (such as, but not limited to, establishment preferences, purchases item/service preferences, time of day when purchases are made, and so forth), in contrast to survey information which is actually supplied by a consumer. card information may include frequency of use (redemption), location of use, current balance, typical balance, and so forth. It is to be appreciated that the information retrieved at step 330 can be used for various purposes such as, but not limited to, aiding in performing steps 340, 350, and 360.

At step 340, one or more ways in which promotion offers are “published” and/or otherwise made public are selected. Step 340 may be performed in the future, for example, at the time a promotion offer is uploaded into the system. It is to be appreciated that step 340 relates to the establishment side and thus actual card subscribers may select a subset of the ways specified in step 340, so that only the subscribers preferred ways are used as opposed to all available ways.

At step 350, one or more promotion offers (hereinafter “promotion offer”) are uploaded into the system 200 and posted at various locations in real-time, so that card subscribers can become aware of the existence of the promotion offer. Such locations can be specified generally (for all promotion offers) at step 340 or can be specified at step 350 specifically for the one or more promotion offers when the one or more promotion offers are initially uploaded into the system.

In an embodiment, the promotion offers are uploaded and posted at a set time of day. It is to be appreciated that the set time of day may vary depending upon business type, business location, the item offered for sale, the service offered for sale, and so forth. Staggering of the promotion offers, as may result from imposed restrictions on when promotion offers may actually be uploaded into the system, can provide many attendant advantages. For example, such staggering spreads out the consumption of system resources, thus avoiding performance and/or communication bottlenecks. As a further example, using specific times of days for certain businesses provides some measure of certainty as to when promotion offers are posted, thus saving consumers time from having to continually check for promotion offers. Further to that end, consumers can select an option through the system where they can automatically be notified of promotion offers, either in general or with respect to certain promotion offers. Further, targeted communications such as voice mails, e-mails, text messages (e.g., text alerts), applications (e.g., application alerts), and so forth can be used to provide promotion offers directly to card subscribers.

At step 360, one or more modifications of existing promotion offers and/or one or more new promotion offers are uploaded into the system and posted in real-time at various locations, so that card subscribers can become aware of the existence of the promotion offers. For existing promotion offers that are modified at step 360, such locations can be specified at step 350 when the promotion offer is initially uploaded into the system or can be modified at step 360 when the modified promotion offer is uploaded into the system.

Step 360 may be performed, for example, on the same day as step 350. In this way, a business can tailor the amount of traffic they would like to see that day as the day is progressing by modifying any existing promotion offers and/or by adding new or supplemental promotion offers. For example, if the promotion offer at step 350 was for 50% of the core value for a meal ticket (i.e., current card value=core value+(core value*0.50)) and was publicized first thing in the morning, then the promotion offer can be modified at step 360 later that same day to be 60% of the core value (i.e., current card value=core value+(core value*0.60)) for a meal ticket with a supplemental promotion offer of half price drinks. In this way, a client can have a way to immediately and dynamically entice customers using deeper discounts than that already provided, for example, even on the same day. Thus, daily influences such as bad weather, bus schedules, and so forth can be determined and acted upon immediately so as to have an effect on the same day.

Referring back to the specific examples implicated by steps 350 and 360 above, we complete the calculation of such examples with exemplary dollar amounts in order to concretely show how the “core value” principle operates. In the following calculated examples, we presume the core value to be $50. Of course, other amounts can be used. Such $50 core value may be purchased (for the full amount or a discounted amount) or given away with the initial offering of the card as a promotion, etc. If the promotion offer at step 350 was for 50% of the core value for a meal ticket (i.e., current card value=core value+(core value*0.50)), then for a core value of $50, the current card value=$50+($50*0.50)=$75. If the promotion offer is modified at step 360 to be 60% of the core value (i.e., current card value=core value+(core value*0.60)), then for a core value of $50, the current card value=$50+($50*0.60)=$80. Thus, to incentivize a potential customer, an establishment may add to the core value of $50 in step 350 to provide an actual redeemable value of $75, and may further modify the actual redeemable value in step 360 to be $80. In this way, an establishment can dynamically incentivize potential customers with various levels of savings that increase as the day progresses.

While one or more embodiments are described herein with respect to a “core value” and modifying of the core value to incentive card subscribers, it is to be appreciated that a percentage discount of an item cost can instead be used in place of the core value based approach or in addition to the core value based approach. A percentage discount of an item cost may simply involve taking a certain percentage off of a current price. In an embodiment, this percentage can be readily changed in real time, similar to changing the current value of the core value as described herein, so as to incentivize card subscribers. That is, if a business has designated early in the morning that the card will provide a 20% savings on any meal purchase (that is, 20% off of the receipt price), the promotion could be later modified that same day to provide a 40% savings on any meal purchase (that is, 40% off of the receipt price) in the case, for example, that business has been slow thus far so as to further incentive customers to come in and redeem the promotion offers.

Of course, the present principles are not limited to the core value modification approach or the percentage discount approach described above, and thus other incentivizing approaches may also be used, while maintaining the spirit of the present principles.

FIG. 4 shows another exemplary method 400 for using payment cards, in accordance with an embodiment of the present principles. Method 400 is primarily directed to receiving and redeeming promotion offers, for example, by a card subscriber (user).

At step 410, a card is received by a new subscriber/user (hereinafter “subscriber”).

At step 420, the subscriber is associated with the card. At step 430, the subscriber selects one or more ways in which the subscriber is to be notified of promotion offers. At step 440, the subscriber optionally selects limits on the promotion offers that are sent to the subscriber. For example, the subscriber may select certain items and/or services that the subscriber is interested in, wherein any promotion offers will be limited to the selected items and/or services. Of course, other limiting indicia may be used, while maintaining the spirit of the present principles. In an embodiment, steps 420, 430, and 440 may be combined into one step. In another embodiment, step 420 is performed earlier, for example, when the card number is registered with the system 200. These and other alternatives are readily contemplated by one of ordinary skill in the art, while maintaining the spirit of the present principles.

At step 440, promotion offers pertinent to the subscriber are disseminated to the subscriber for consideration. Step 440 may include new promotion offers as well as modified promotion offers. For example, modified promotion offers may offer more incentive than an early promotion offer for a same item or service. As noted above, the subscribers may limit the promotion offers provided to them based on various parameters.

At step 450, one or more promotion offers are instantly redeemed at a point of sale.

In an embodiment, card vouchers are purchased online, which entitles consumers to receive promotion deals (e.g., intermittently, daily, and/or at some other pre-designated frequency) from merchants near them. Restaurant operators can modify card offers electronically, depending on their real-time business needs.

Modifying promotion levels on a card is made possible via a secure online user interface (e.g., implemented as a dashboard in one implementation) where merchants can select and manage their offers at a moment's notice. Promotion details are uploaded instantly and posted in real-time on the local homepage directory (as well as on a particular restaurant's profile page), on pre-designated web platforms, on smartphone mobile applications, and so forth. Local listings that feature the latest incentives will target subscribers within close proximity of the restaurant and will be distributed to consumers through a choice of several channels, including e-mail, phone applications, various social media channels, and so forth.

The present principles enable consumers to make impulsive decisions on where to dine through the power of customized promotional offers that can be created and modified based on a merchant's real-time needs. Offers are fulfilled via card vouchers, a one-of-a kind payment and loyal card platform whose real-time promotions can be assigned electronically and redeemed using an establishment's POS system. For participating restaurants, it allows operators to attract new customers, retain existing ones, and stimulate incremental spending.

In an embodiment, the present principles can be implemented (e.g., along with requisite hardware including, but not limited to a memory device and a processor) in the form of Point of Sale software, which can be remotely installed into any MICROS or ALOHA POS network. The present principles offer advantages that GROUPON and LIVINGSOCIAL do not, including, but not limited to, the following: (1) the ability to electronically modify offers in real-time; and (2) the ability to redeem those offers instantly at a point of sale. These integral benefits alone protect the present principles from “group buying” competitors, thus inheriting substantially more bargaining power within the restaurant community.

The present principles provide a platform that allows restaurant merchants to modify the promotional portion of an iCard. Active card holders are incented by daily deals (promotion offers), the details of which are determined by authorized restaurant personnel. Modifying the promotion values or incentive levels of a card is made possible via a secure online interface where merchants can easily manage their offers in real-time. In an embodiment, the promotion values of cards can be altered from 10% to as high as 100% of the cards' core value. Of course, other ranges can be used. From this interface, the merchant can also set the promotional timeframe, down to the minute.

Promotion details are uploaded instantly and posted at various locations. In an embodiment, promotion details are uploaded instantly and posted on or at the homepage directory of a particular restaurant association's web platforms, the web site of the particular restaurant running the promotion offer, smartphone applications, various social media web sites, various specified e-mail addresses, and so forth. In an embodiment, the web platforms of a restaurant association known as DINERSGROUP are used. However, it is to be appreciated that the present principles can be affiliated with any restaurant association. Local listings that feature the latest promotional offers will target subscribers within close proximity of the restaurant and will be distributed to consumers through a choice of several platforms as noted above.

The present principles allow card vouchers to be redeemed instantly at a point of sale at any participating restaurant location. This method removes the need for hard copy checklists of cardholders; a brick and mortar technique used by GROUPON and LIVINGSOCIAL in an effort to track voucher redemptions. When the redemption code on an iCard voucher is scanned (or manually entered into the POS system upon closing a check), the food and beverage sale is deducted from the guest check and the non-promotion balance, if any, is carried over.

Not only does this redemption method dramatically reduce the risk of card fraud, it actively tracks consumer spending and buying behavior from one visit to the next without lifting a finger. In an embodiment, when a restaurant merchant redeems an iCard voucher, the accounting is automatically reflected in his or her daily reporting (or based on some other time unit). In an embodiment, the iCard's core value and promotional value are broken down as well. Merchants, whose restaurants are credited with an iCard sale, are paid within a set amount of time from the date of redemption (e.g., two weeks). Additionally, guest databases are stored in separate records for each restaurant and may be organized to display all demographic trends, including their dining history based on prior redemption activity, and so forth.

Consumers who visit participating establishments will likely be among the first to hear about the iCard program. The reason for this is simple: every day, guest checks will feature messaging that will ask diners to participate in a satisfaction survey, which the diners can access by going to the bottom of the restaurant's website or via a mobile application. Survey codes and their corresponding QR barcodes (enabling smartphone users to gain immediate access to the survey) are printed at the bottom of every dining check, linking wait staff and menu detail to the questionnaire.

In an embodiment, data regarding the table's food and beverage order is transmitted to appear on the online survey in real-time, resulting in accurate feedback and critical information about a customer's recent experience. The survey asks diners to share their thoughts on specific entrées and their overall dining experience, allowing merchants to identify their guests' needs and alert them to menu and service-related shortfalls that would otherwise go unreported or unnoticed. Survey results are displayed in a comprehensive manner and delivered or retrieved instantly in easy-to-read graphs and charts and may be grouped by demographic categories or calendar range. Any written comments from the surveys are made available in real-time and can be accessed online by authorized restaurant personnel.

Upon completing the survey (and as a show of appreciation for their feedback), respondents are redirected to the card landing page where they may choose to purchase payment card balances in $5 increments, ranging from $20 and $50 in value (of course, other values cane be used). The partnering merchant determines the values of the incentive (or “promotion value”) for his restaurant on a day-by-day and/or weekly basis. The access-secured dashboard provides the tools necessary to assign a different promotion value for each day of the week, e.g.: a merchant applies a 50% promotional incentive on the anticipation that card vouchers will be redeemed at his restaurant this Wednesday; followed by a 40% incentive on Thursday. Thus, if a card is purchased for $30 (the “core value”), the card can then be redeemed for $45 ($45=$30+(50% of $30)) on Wednesday or $42 ($42=$30+(40% of $30)) on Thursday.

As an alternative incentive to the value increase, merchants may choose to announce half-price cocktails or appetizers on a particular day of the week during a specified length of time. In this case, a card voucher that gets redeemed during this chosen time frame will prompt the restaurant's POS system to automatically reduce the price of all cocktails or appetizers from the dining check accordingly. There are several other options to choose from including, but not limited to, the following: two-for-one appetizers and entrées; or a discounted price fixed dinner that merchants can assign within a two hour window during any day of the week.

Merchants are more inclined to keep their promotion values higher during the days of the week they typically experience less volume in an effort to attract more customers. Conversely, a merchant may choose certain days where no added values are assigned, like in the case with weekends when business is generally at a more satisfactory level. Cards with a zero promo balance (worth no more than their core value) can still be honored and redeemed at any participating establishment.

Survey respondents who opt out of purchasing a payment card are asked to provide an email address, which in turn authenticates the survey results. It also offers an opportunity to build its subscriber base and alert consumers to the card program in the future. To strengthen the response rate of each survey, partnerships can be formed with, for example, a credit card company to sponsor a monthly sweepstakes where a prize can be awarded randomly to a chosen respondent each month. Survey respondents can also be offered a $10 incentive (or other amount) towards the purchase of a $50 card (or other amount). Thus, in such a case, the text at the bottom of each guest check can read as follows: “Tell us what you think. Take our online survey and well take $10 off your next payment card purchase. Enter the following survey code at the bottom of our homepage. Or scan the barcode from your mobile application.”

Every morning, card holders are notified of recently posted promotions within their area, for example, via a single email alert listing several restaurants near them along with their latest incentives. These promotion alerts can be custom tailored by subscribers to feature one of several delivery methods. Merchants may decide to post their incentives on impulse, just a few hours prior to the starting point of a promotion, which would in turn prompt a secondary alert to local subscribers/cardholders. In an embodiment, the first daily promotion is set to go live shortly after midnight (or some other time) and can only be modified thereafter if the merchant chooses to increase the promotion's percentage and/or if other incentives are added (i.e.: an instant “happy hour” announcing half-priced appetizers from 5 to 7 pm). The delivery of such deal alerts are exclusive to live card holders and can be reinstated only if a new card is purchased. Subscribers can be offered customized delivery options where they can choose to block the secondary promotion alert or even cherry pick the local restaurants whose promotions they prefer only to view. Secondary (same-day promotion) alerts can be subjected to additional fees that are incurred by the merchant.

A restaurant association (e.g., DINERSGROUP) can be tasked with distributing promotion offer information directly through several platforms, which can include daily emails, its homepage (e.g., at DINERSGROUP.COM), its mobile applications and several of the top social networks. Of course, the system may include several of its own platforms on which to publish promotion offers, or may directly utilize existing platforms. To increase further awareness of the card, various online affiliates can be engaged to display and promote its deals on their websites, and various online brands can be collaborated with to distribute its deals. Various customer loyalty and reward programs can be used to build brand loyalty and provide customers with incentives to buy cards. For example, when customers perform qualifying acts, such as providing a referral to a new subscriber, the customer can be issued credits that can be redeemed for awards, such as adding, for example, a 10% promotion incentive to their existing card accounts.

Consumers who visit DINERSGROUP.COM will be prompted to register as a subscriber upon their first visit to the website. The website's homepage will feature a listing of restaurants within close proximity to the subscriber (or based on the Internet Protocol (IP) address should the consumer browse the site prior to joining) The website will also provide opportunities to engage with the DINERSGROUP community through (1) its blog that will be maintained by the Company's staff, (2) DINERSGROUP Meet-ups, a forum for meeting with others to redeem card vouchers at a particular location, (3) DINERSGROUP INSTAGRAM, a collection of digital photos of dishes and venue images from subscribers, and (4) a rewards program for referring new subscribers.

Consumers can also access deals through mobile applications. These applications will enable consumers to browse, purchase and manage card deals on their mobile devices as well as access the latest promotion values offered by restaurants based on the location of the subscriber.

Daily deals can be published through various social networking sites and notifications of the same can be adapted to the particular format of each of these social networking platforms. The website and mobile application interfaces will enable consumers to push notifications of local deals to their personal social networks.

Regarding technology, in an embodiment, we use a common platform that includes administrative tools to track internal workflow, applications and infrastructure to serve content at scale, dashboards and reporting tools to display operating and financial metrics for historical and ongoing deals, and a publishing and purchasing system for consumers. Scaling can be readily performed to accommodate increasing numbers of subscribers by adding relatively inexpensive industry-standard hardware or using a third-party provider of computing resources. As for financial transactions, Secure Socket Layer (SSL) is used to provide encryption in transferring data.

Regarding merchant services, once a contract is signed, a merchant representative will initiate the first of several communications with the restaurant operator to introduce him to the tools necessary to manage his promotions and describe how the survey and redemption data is retrieved for customer analysis. These tools can help operators analyze status updates on deal performance, analytics that measure purchase traffic and demographic information of diners, a capacity calculator to estimate demand for the deal ahead of its feature date, and a calculator that estimates the return on investment that the merchant receives from the deal. These tools can be made accessible using a password-secured online account.

Regarding a restaurant's profile page, the same can include a full description about the venue, information about its menu, and any features the proprietor wishes to include in the editorial.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of” for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A processor-based method for using payment cards, comprising:
issuing promotion offers pertaining to the payment cards in real time; and
redeeming the promotion offers in real time at a point of sale.

2. The method of claim 1, wherein the promotion offers comprise new promotion offers and existing promotion offers pertaining to the payment cards, and said issuing step comprises:
issuing the new promotion offers in real time; and
modifying the existing promotion offers in real time.

3. The method of claim 1, wherein the promotion offers target subscribers within a given distance range of a particular establishment.

4. The method of claim 1, wherein the promotion offers specify a seller-inputted validity time period during which one or more corresponding promotions are valid.

5. The method of claim 1, wherein the promotion offers are issued at least one of intermittently, daily, and at some other pre-designated frequency.

6. The method of claim 1, wherein said issuing step comprises posting the promotion offers in real-time at one or more locations.

7. The method of claim 6, wherein the one or more locations comprise at least one of an on-line directory, a corresponding establishment's profile page, a pre-designated web platform, and a smartphone mobile application.

8. The method of claim 1, wherein each of the payment cards have a respective core value applicable to the promotion offers, and the method further comprises incentivizing the payment cards by modifying a currently redeemable value of the respective core value.

9. The method of claim 8, wherein a given promotion offers alters the core value with respect to a specific percentage of the core value that is added to the core value to obtain a current discount value applicable to a current redemption of the given promotion offer.

10. The method of claim 9, wherein the specific percentage of the core value that is added to the core value to obtain the current discount value is based at least in part on a level of responsiveness of survey results.

11. The method of claim 10, wherein the level of responsiveness comprises at least one of a number of surveys responded to in a designated time period and an amount of detail provided in answers to survey questions.

12. The method of claim 1, wherein the promotion offers are provided to consumers via an e-mail, a text message, a voice message, a commercial website, and a social media network.

13. The method of claim 1, wherein a redemption process applied to the payment cards for redemption of the promotion offers comprises tracking consumer spending and buying behavior.

14. The method of claim 1, further comprising storing information relating to the consumer spending and buying behavior in a database.

15. The method of claim 14, wherein the information stored in the database is available for review by authorized personnel.

16. The method of claim 1, wherein the payment cards are incentivized based on survey.

17. The method of claim 16, further comprising storing survey results in a database for review by authorized personnel.

18. The method of claim 1, further comprising incentivizing the payment cards by providing a discounted rate on certain items sold by a corresponding establishment, the discounted rate pertaining to a particular period of time during a particular day of the week.

19. The method of claim 18, wherein the certain items comprise at least one of cocktails and appetizers.

20. The method of claim 1, further comprising notifying holders of the payment cards of recently posted promotion offers, the recently posted promotion offers at least specifying an establishment and a corresponding one or more incentives applicable to a redemption of the payment cards at the establishment.

21. The method of claim 20, further comprising receiving a notification type selection, the notification type selection specifying a communication type to be used to provide promotion offer notifications to the holders of the payment cards.

22. The method of claim 20, wherein said notifying step comprises providing a promotion offer notification during a first promotion offer specifying time period and providing another promotion offer notification during a second promotion offer specifying time period, the first promotion offer specifying time period being fixed and the second promotion offer specifying time period being optional and dynamically determined.

23. The method of claim 22, wherein the first promotion offer specifying time period is based on at least one of a business type, a business location, an item offered for sale, and a service offered for sale.

24. The method of claim 22, wherein the second promotion offer specifying time period is based on at least one of bad weather and bus schedules.

25. The method of claim 22, wherein a use of the second promotion offer specifying time period is based on an amount of business at the establishment in an immediately preceding range of hours occurring on a same day as the second promotion offer specifying time period, the second promotion offer specifying time period being used when the amount of business is less than a threshold amount of business.

26. The method of claim 22, wherein the second promotion offer specifying time period relates to a given promotion offer that is pre-registered with a payment card system, such that the given promotion offer is issued in real time automatically responsive to a determination being made that the amount of business at the establishment in the immediately preceding range of hours occurring on the same day as the second promotion offer is less than the threshold amount of business.

27. The method of claim 1, further comprising providing a loyalty reward program for the payment card.

28. The method of claim 1, wherein the payment card is used as at least one of a gift card, a loyalty card, a credit card, a debit card, a charge card, and a stored-value card.

29. A payment card system, comprising:
a payment card management server for issuing promotion offers pertaining to payment cards in real time; and
a point of sale redeeming server for redeeming the promotion offers in real time at a point of sale.

30. The system of claim 29, wherein the promotion offers comprise new promotion offers and existing promotion offers pertaining to the payment cards, and said payment card management server issues the new promotion offers in real time, and modifies the existing promotion offers in real time.

31. The system of claim 29, wherein the promotion offers target subscribers within a given distance range of a particular establishment.

32. The system of claim 29, wherein the promotion offers specify a seller-inputted validity time period during which one or more corresponding promotions are valid.

33. The system of claim 29, wherein said payment card management server issues the promotion offers at least one of intermittently, daily, and at some other pre-designated frequency.

34. The system of claim 29, wherein said payment card management server issues the promotion offers by posting the promotion offers in real-time at one or more locations.

35. The system of claim 34, wherein the one or more locations comprise at least one of an on-line directory, a corresponding establishment's profile page, a pre-designated web platform, and a smartphone mobile application.

36. The system of claim 29, wherein each of the payment cards have a respective core value applicable to the promotion offers and is incentivized by modifying a currently redeemable value of the respective core value.

37. The system of claim 36, wherein a given promotion offers alters the core value with respect to a specific percentage of the core value that is added to the core value to obtain a current discount value applicable to a current redemption of the given promotion offer.

38. The system of claim 37, wherein the specific percentage of the core value that is added to the core value to obtain the current discount value is based at least in part on a level of responsiveness of survey results.

39. The system of claim 38, wherein the level of responsiveness comprises at least one of a number of surveys responded to in a designated time period and an amount of detail provided in answers to survey questions.

40. The system of claim 29, wherein the promotion offers are provided to consumers via an e-mail, a text message, a voice message, a commercial website, and a social media network.

41. The system of claim 29, wherein a redemption process applied to the payment cards for redemption of the promotion offers comprises tracking consumer spending and buying behavior.

42. The system of claim 29, wherein said management server stores information relating to the consumer spending and buying behavior in a database.

43. The system of claim 42, wherein the information stored in the database is available for review by authorized personnel.

44. The system of claim 29, wherein the payment cards are incentivized based on survey.

45. The system of claim 44, wherein said management server stores survey results in a database for review by authorized personnel.

46. The system of claim 29, wherein the payment cards are incentive by providing a discounted rate on certain items sold by a corresponding establishment, the discounted rate pertaining to a particular period of time during a particular day of the week.

47. The system of claim 46, wherein the certain items comprise at least one of cocktails and appetizers.

48. The system of claim 29, wherein said management server causes holders of the payment cards to be notified of recently posted promotion offers, the recently posted promotion offers at least specifying an establishment and a corresponding one or more incentives applicable to a redemption of the payment cards at the establishment.

49. The system of claim 48, wherein said management server receives a notification type selection, the notification type selection specifying a communication type to be used to provide promotion offer notifications to the holders of the payment cards.

50. The system of claim 48, wherein said management server initiates a promotion offer notification during a first promotion offer specifying time period and initiates another promotion offer notification during a second promotion offer specifying time period, the first promotion offer specifying time period being fixed and the second promotion offer specifying time period being optional and dynamically determined.

51. The system of claim 50, wherein the first promotion offer specifying time period is based on at least one of a business type, a business location, an item offered for sale, and a service offered for sale.

52. The system of claim 50, wherein the second promotion offer specifying time period is based on at least one of bad weather and bus schedules.

53. The system of claim 50, wherein a use of the second promotion offer specifying time period is based on an amount of business at the establishment in an immediately preceding range of hours occurring on a same day as the second promotion offer specifying time period, the second promotion offer specifying time period being used when the amount of business is less than a threshold amount of business.

54. The system of claim 50, wherein the second promotion offer specifying time period relates to a given promotion offer that is pre-registered with a payment card system, such that the given promotion offer is issued in real time automatically responsive to a determination being made that the amount of business at the establishment in the immediately preceding range of hours occurring on the same day as the second promotion offer is less than the threshold amount of business.

55. The system of claim 29, wherein said management server comprises a payment card manager for managing a loyalty reward program for the payment card.

56. The system of claim 29, wherein the payment card is used as at least one of a gift card, a loyalty card, a credit card, a debit card, a charge card, and a stored-value card.

57. A non-transitory recording medium comprising a computer readable program that when executed by a computer system causes the computer system to perform the following steps:
issuing promotion offers pertaining to the payment cards in real time; and
redeeming the promotion offers in real time at a point of sale.
